(19) United States
(12) Patent Application Publication
(10) Pub. No.: US 2007/0048420 A1
(43) Pub. Date: Mar. 1, 2007

(54) MEAT PRODUCTS MARKED OR ENGRAVED ON THEIR EXTERNAL SUFACE AND METHOD FOR MAKING SAME

(76) Inventor: JOSE BARBOSA MACHADO NETO, Sao Paulo (BR)

Correspondence Address: NOTARO AND MICHALOS, 100 DUTCH HILL ROAD, SUITE 110, ORANGEBURG, NY, 10962-2100, US

(21) Appl. No.: 11/551,867

(22) Filed: Oct. 23, 2006

Related U.S. Application Data
(62) Division of application No. 10/686,288, filed on Oct. 15, 2003.

(30) Foreign Application Priority Data
Oct. 10, 2003 (BR) PI0303043-1

(51) Int. Cl. A23G 3/28

(52) U.S. Cl. 426/383

(57) ABSTRACT

A meat part product marked or engraved and method for its marking or engraving, in low or high relief, containing a marking or engraving above or below an external surface plane. The meat part can be pieces, cubes, slices or milled portions, sausages and/or any other form of meat of any origin, such as bovine, swine, poultry, fish, buffaloes, filled in natural and/or artificial tripes, which can be in the raw, baked, fried, cooked, cured, dried state, originating or not from preparation stages, seasoned or not. The meat parts are forwarded to equipment producing heat or rays, with the possibility of laser rays, preferably regulated by PLC—Programmable Logic Controller, so that, according to the type of meat, the type of marking or engraving in low or high relief will be identified and which will not disintegrate or dissolve, even after the preparation for final consumption.

### CROSS-REFERENCE TO RELATED APPLICATION

This is a divisional application Ser. No. 10/686,288 filed Oct. 15, 2003, entitled Marking and Engraving Means Applied over the External Surface of Meats in General, which is incorporated here by reference and which claims priority on Brazilian Patent Application number P10303043-1 filed Oct. 12, 2003, priority claim of which is repeated hereby.

### FIELD AND BACKGROUND OF THE INVENTION

The present invention is directed to an apparatus or means for marking or engraving The external surfaces of meats in general and the resulting products. The meats to be marked or engraved may be in any physical state or size, and may be in big or small parts, whole pieces, slices, cubes, milled portions (ground meat, hamburgers, meatballs) sausages or other forms which will hereby simply be referred to as processed meat parts. These processed meat parts may be of any origin, for example, bovine, swine, poultry, fish, buffaloes, filled in natural and/or artificial tripes and other kinds. The meat parts may be in a raw state, or semi-raw states, that is, pre-cooked, pre-baked, pre-fried, pre-cured, pre-dried or pre-smoke-dried, seasoned or not.

The present invention refers more specifically to equipment or devices for producing calories (heat) or rays, including laser rays, with the adequate intensity which is automatically regulated according to the type of meat to be marked, its texture, size, state, with the aim of marking or engraving the meat body in low or high relief, to reproduce logos and further technical information, product identification codes, on the referred meat part, thus allowing the marking or engraving effected to be recognized visually, by touch or laboratory analysis.

As is known both by consumers and food product manufacturers in general, a wide range of graphical indications exist on products to be commercialized, such as logotype, origin, production batch, date of expiry, etc. and is a mandatory condition, being mostly applied to the packing of the product to be consumed or even by means of stamps, paper enclosures, plastics or any other known and appropriate means.

Producers are very concerned to develop means to identify the food product to be Commercialized, and especially at a moment when, in different countries, animal diseases have affected entire herds or breedings, affecting the quality of produced meat, with traditional marking or engraving means occurring simply on the packing which can be maintained for the longest possible time conditioning the meat products, to make the product trademark remain visible for more time, but also aiming at maintaining all the information related to the product together with the product, thus ensuring customer confidence. Traditional marking or engraving means carried out directly on the product may be easily withdrawn by cutting the marked or engraved part, with this feature being overcome by the present invention.

Meats supplied in raw pieces or parts (refrigerated or frozen) carry, for example, marks or identifiers applied by means of stamps with inks of different colors, usually applied over areas with lower human consumption, such as on fat covering the meat. However, as known, apart from the resulting very bad esthetical appearance, inks may contaminate the product and they are not totally hygienic, apart from being easily extractable from the meat body.

Another model used to identify meats and similar products, usually still in the raw state is the one using plastic elements, such as seals fastened to the product itself, showing its origin, performing the task of a certifying element. These seals must be taken off the product before the food is prepared, since they are made of material, which is not resistant to heating while cooking or preparing the product.

It is known that, in the case of sausages or similar products, packs are usually made of multiple-layer plastics, especially developed to protect the product from light rays and also from the paint of graphical printing, thus generating added costs to the product.

In the case of products sold as “ready dishes”, which are already seasoned and previously cooked/baked/fried, these are wrapped in diverse packings, developed under the highest conservation and sterilization standards, which are usually maintained under refrigerated storage, also allowing their heating by microwave or common ovens, and the identification of which are limited to the printings of their own packs.

The problem found in all the kinds of identifiers as mentioned above is the fact that, once the product is taken out of its respective package, seal or cover, either for immediate consumption, or to be later prepared, it starts to be exposed with no identification, i.e., once its identifying means is removed, it is not longer possible to identify its origin, producer, expiry or batch indications, etc. which can cause trouble in case of refusals or returns by consumers or even by distributors. Another problem found is that, this type of process usually occurs through the marking method, which, when carried out on the product itself, is easily removed because it involves only the cover of the product and a simples cut on the marked part already eliminates any possibility of product identification.

### SUMMARY OF THE INVENTION

As a consequence of the above, and especially due to the current market and sanitation authority needs of each country, over the so far existing state of the art, the applicant developed a marking or engraving means as applied over external surfaces of meats in general, reaching extensive internal ranges of the meat body, comprising more particularly an automatic or manual equipment provided with a heat producing device of adequate heating intensity, or laser ray applier, able to produce marks or engravings in low or high relief over at least one meat surface, making it recognizable visually, by touch or still by laboratory analysis, even after final preparation for consumption.

One of the main purposes is therefore to make the commercialized meat be provided with marks or engravings that can be recognized at any time, either at the time of purchase, wrapping up in a package or not, and still during its consumption.

One of the preferred embodiments of the present invention consists of the fact that the marking or engraving can be done by means of a laser beam or laser ray applying device, with wavelengths obtained by different components (gas, crystal, liquid, chemical reaction, etc.) with the rays being previously regulated by PLC (programmable logic controller) with or without monitoring sensors, which can be used, for example, to recognize the type of meat to be marked, its texture, grammage, and control printing tones, shapes, statements, figures and further information. Also pointed out as a technical solution through this equipment and process, is its capability of automatic self-adjustment, adapting and regulating the ray intensity, through the PLC, to allow a level of excellence in the marking of meats of small sizes (cubes, slices, milled portions) and still the ablation of fat in meats of bigger sizes, allowing the marking or engraving, in low or high relief, directly on the meat body.

According to another embodiment to obtain the marks or engravings, in low or high relief, over the meat, as described by the present invention, is by means of an equipment provided with a hyper-heated metal head by means of a resistance or equivalent, with the said head getting close to the meat surface, touching it or not, so as to mark its surface.

Once the meat is marked with all the required information, it goes on to the following production stages, i.e., packing or direct distribution to consumers, and it may or may not be refrigerated and the information printed on the meat body resulting from the marking or engraving, in low or high relief, have the guaranteed capacity of printing, which will not disintegrate, even if it goes through any processing for final consumption, and the identification of which will be possible through laboratory analysis.

The processed meat part, therefore, now contains all the information for final consumers and/or any other interested party, including sanitation control or government institutions, thus ensuring confidence for the trademark and product quality, apart from the fact that, in case of rejection by the consumer, at the moment of consumption, he or she can wrap the product in any kind of packing and take it to the distributor where it was purchased or even contact the producer to be reimbursed, causing the whole chain round, i.e., to find out the problem causing the said rejection This can be extended to restaurants and similar facilities, since all the markings and engravings can be found on the product to be consumed, independently of the meat size or state.

The marked or engraved meat part, in low or high relief, as per the means mentioned herein, allow the relation between manufacturer/distributor and consumer to be strengthened, since the offered product now show the original mark on the product up to the time of its consumption.

### BRIEF DESCRIPTION OF THE DRAWINGS

To complement the present description and obtain a better understanding of its features and according to its preferred practical embodiments, the description is followed by an attached set of figures, in which the following was represented as examples, but in a non-limiting manner:

FIG. 1 illustrates an automatic means or apparatus to mark the external surface of meat Parts, including feeding to the marking equipment, any kind of meat, prepared or not, and engraving it with the appropriate device and the resulting finished meat product.

FIG.2 is the schematic section of a meat part, such as a symbolic slice of meat, already marked, by the means shown in FIG. 1.

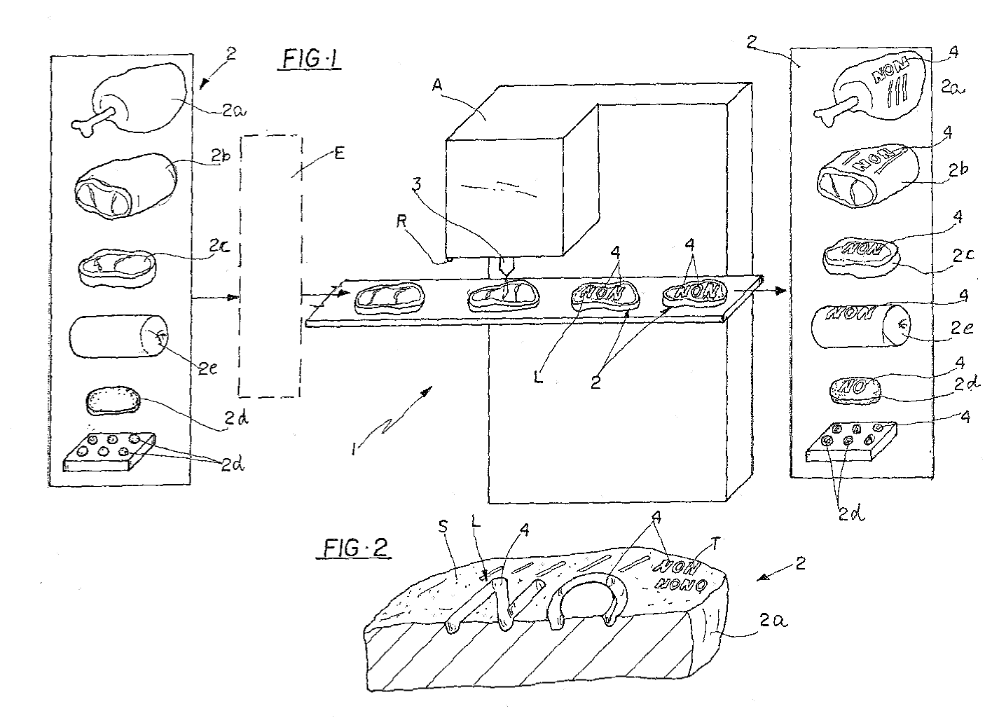

### DESCRIPTION OF THE PREFERRED EMBODIMENTS

Concerning the illustrated figures, the present invention refers to a marking or engraving means, in low or high relief, for the external surface of meats in general and resulting products, with the marking or engraving means 1 being automated (A) or manual and applied over the external surface S of a processed meat part 2 in general, meats as obtained in parts 2a, or pieces/cubes 2b, or slices 2c, or milled portions, hamburgers, meatballs, or the like, 2d, or sausages 2e and/or any other form of meat 2 of any type or origin (bovine, swine, poultry, fish, buffaloes, filled in natural and/or artificial tripes and other kinds), raw (refrigerated or frozen), baked, fried, cured, dried, smoke-dried, or other states, originating or not from preparation or preparation stages E, i.e., where the meats are seasoned or not. The meat parts are forwarded or conveyed in the direction of the arrows to the equipment or devices 3 for the production of calories or heat or rays with the adequate intensity. The heat or rays are preferably regulated by PLC (Programmable Logic Controller), so that, according to the type of meat to be marked or engraved, the high or low relief are applied and obtained, and that for example produce information like logotypes L and additional technical information T related to the meat part on the surface S of meat 2, enabling its recognition, visually, by touch, or laboratory analysis, by the consumer or interested party. The pattern, thus, contains at least one identifying and technical information concerning the meat part and has a low or high relief which is out of, above or below the external surface plane S, reaching big extensions of the meat body without disintegrating it or affecting its consistency, independently of the type of meat, its texture, state it is in (raw or semi-raw) and size.

A marking or engraving mean can be embodied by means of devices applying rays emitted in a pattern onto the meat part surface S from device 3, the wavelengths of which are obtained from different components (gas, crystal, liquid, chemical reaction, etc.) with the rays previously regulated by PLC, with or without monitoring sensors R, which can be used, for example, to recognize the type o meat to be marked, its texture, grammage, state and intensity control of the print, forms, statements, figures and additional information, forming prints 4 in low or high relief.

Another way to obtain markings or engravings 4 on meat 2, according to the present invention is by means of an equipment provided with a hyper-heated metal head by means of a resistance or equivalent, with the production of regulated calories to mark or engrave the meat surface as soon as it comes close to or touches the meat surface, forming engravings 4 in low or high relief.

Although the present invention is detailed, it is important to understand that its application is not limited to the details and stages described hereby. The present invention allows other modes and can be practiced or executed in a variety of modes by its inventor against the parameters presented hereby. It should be understood that the terms used herein are merely used for description and not for limitation purposes.

What is claimed is:

1. A meat product comprising:
a meat part, of any size, state, texture, with an external surface marked or engraved in low or high relief, above or below the external surface, with the pattern containing information related to at least one parameter of the meat part;
the meat part being marked or engraved by a process comprising:
identify the type of meat, its size, thickness, texture, state, animal origin, fat content and other features;
move the meat part until identifying the initial surface the marking or engraving device is capable of reaching it;
identify and regulate the type of equipment that will be used in the marking or engraving process, that is, hyper-heated metal head through resistances or equivalents, or laser rays;
identify in the marking or engravings device, the information to be printed, the speed, wavelength, depth, printing intensity;
apply the marking or engraving in low or high relief according to the features of the meat product;
clear the marked or engraved meat body in order to check if the printed information is correct; if not, discard because marking or engraving cannot be eliminated from the meat.

2. The meat product according to claim 1, where the heat or ray intensity are controlled by PLC, based on the type of meat identified, with the process including the use a sensor for recognition of at least one parameter of the meat part to be marked or engraved, selected through one of its physical features, meat texture and grammage.

3. The meat product according to claim 2, in which the marking or engraving of the meat part is carried out by a laser ray with a wavelength selected according to the features of the meat body, in order to form a pattern, in low or high relief.

4. The meat product according to claim 2, in which the marking of the meat part is carried out by a hyper-heated metal head close to or in contact with the external surface of the meat part in order to form the pattern.

5. The meat product according to claim 1, in which the meat part is a piece of meat, a part of the piece, a cube of meat, portions of a slice of meat, milled portion, meat sausage, containing or not bones or fat plates, strings, fibers.

6. The meat product, according to claim 5, in which the meat part is at least of the bovine, swine, poultry, fish, buffaloes type in its natural or semi-raw state.

7. The meat product according to claim 1, in which the meat part is processed in its natural stage—raw or semi-raw, that is, having been pre-processed to be in at least a state of refrigerated, frozen, pre-baked, pre-fried, pre-cured, pre-dried and pre-smoke-dried, seasoned or not.

8. The meat product according to claim 7, in which the meat part enters the marking or engraving device, in any type of size or state, the features of which will define if it will be marked or engraved and still in low or high relief, in order to avoid losing its original features and to be identified by different means, including laboratory analysis, even after preparation for final consumption or even consumed by the final consumer.

9. The meat product according to claim 1, in which the meat part can be in its natural state—raw or semi-raw, refrigerated, frozen, seasoned or not, with fat covers, small or big quantities of strings and fibers, if it will be marked or engraved, in low or high relief, above or below an external surface plane, being carried out by a laser ray with a wavelength selected to form a pattern and where the meat part enters the device, which after identifying it promotes the marking or engraving in low or high relief.

10. The meat product according to claim 1, after being marked or engraved, in low or high relief, above or below the external surface plane, will not have the printing resulting from the marking or engraving process in low or high relief disintegrated or adulterated, maintaining the printed characters even after preparation for final consumption, allowing its identification through visual perception or touch and even through laboratory analysis for the recognition of its origin and features.

11. A method for making a meat product comprising:
maintain the meat in the raw or semi-raw state, or process it to form a processed meat part with an external surface:
marking or engraving of the meat part applying to the external surface of the natural or processed meat part a pattern of low or high relief which is above or below the external surface plane, with the pattern containing information related to at least one parameter of the identified meat part, with the step of marking or engraving applied by heat or rays;
programmable logic controlling the intensity of heat and rays to carry out the marking or engraving;
identify the features of the meat and move the raw or processed meat part to a location where the processing step of the marking or engraving is carried out;
identify the meat features and move the raw or processed meat part to the processing step of marking or engraving to be carried out in low or high relief; and
after the pattern is applied to an external surface, move the meat part far away from the location where the step of marking or engraving was carried out, in order to check the executed process.

12. The method according to claim 11, where the step of marking or engraving, in low or high relief, is carried out with the control of heat or ray intensity based on a type of meat part in its raw, semi-raw or processed state, and recognizing at least one parameter of the meat part to be marked.

13. The method according to claim 11, where the step of marking or engraving is carried out using a laser to generate rays, with the laser having a wavelength selected according to the meat features, acting in low or high relief, above or below an external surface plane.

14. The method according to claim 11, where the marking or engraving device includes a hyper-heated metal head to be close to or touch above or below an external surface plane of the meat part, in order to form the pattern.

15. The method according to claim 11, where the marking or engraving is carried out, in low or high relief, in any type of meat size, with the possibility of being a piece of meat, a cube of meat, a slice of meat, milled meat, portions of milled meat or a meat sausage.

16. The method according to claim 15, where the marking or engraving is carried out, in low or high relief, in any kind of meat, of at least one type bovine, swine, poultry, fish, buffaloes, and with the possibility of being filled in natural and artificial tripes.

17. The method according to claim 11, where the marking or engraving is carried out, in low or high relief, on meat body, independently of size, thickness, texture, even containing fat plates, strings, fibers, internal or external, the marking or engraving of which will reach the meat and which will not dissolve even after preparation of the foodstuff, with the fat cover, strings and fibers dissolved by frying, cooking or similar process, because the marking or engraving process reaches and surpasses the fat plates, strings and fibers, reaching directly and on an extensive depth the meat body.

18. The method according to claim 17, where the processing step includes the seasoning of meat part, pre-baking or pre-cooking, before being moved to a location for the step of marking or engraving in low or high relief.

19. The method according to claim 11, with the marking or engraving step, in low or high relief, being carried out with the use of a laser to mark the meat part, with the laser having a wavelength selected to form the pattern and where the meat part enters in the marking step after being seasoned in the processing step.

20. The method according to claim 11, where the marking or engraving step includes the control of the heat or ray intensity identified according to the features of type of meat part, with the method including the monitoring of at least one parameter of the meat part to be marked or engraved, in low or high relief, with the marking or engraving being carried out by a laser to generate rays, with the laser having a wavelength selected to form the pattern according to the type of meat body.

21. The method according to claim 11, where the marking or engraving step, in low or high relief, is carried out by a hyper-heated metal head which is moved close to or touches the external surface of the meat part, which can be a piece of meat, a cube of meat, a slice of meat, a portion of milled meat and a meat sausage and the processing step also being to process meat parts that are at least one type of bovine, swine, poultry, fish, buffaloes, filled in natural or artificial tripes, in any state, size, thickness, texture, maintaining the marked or engraved features intact on the meat body, without the possibility of being violated, even after preparation for final consumption, facilitating their identification at any moment, especially through laboratory analysis.
